(19) United States
(12) Patent Application Publication
(10) Pub. No.: US 2018/0014525 A1
(43) Pub. Date: Jan. 18, 2018

(54) BLOWER TO SPRAYER CONVERSION

(71) Applicant: Kevin Bennington, Virginia Beach, VA (US)

(72) Inventor: Kevin Bennington, Virginia Beach, VA (US)

(21) Appl. No.: 15/647,859

(22) Filed: Jul. 12, 2017

Related U.S. Application Data
(60) Provisional application No. 62/362,759, filed on Jul. 15, 2016.

(51) Int. Cl. A01M 7/00; B05B 7/24; B05B 7/30; B05B 7/00

(52) U.S. Cl. CPC A01M 7/0003; B05B 7/30; B05B 7/2427; B05B 7/2416; B05B 7/00

(57) ABSTRACT

Apparatus for converting a powered air blower to a sprayer is disclosed. The apparatus comprises at least one discharge port terminating in a nozzle and at least one clamp, such as an alligator jaw. The clamp may open in a direction away from a direction of discharge from each nozzle. The clamp and the at least one discharge port may be mounted on a chassis having a configuration of a tube. A feed conduit is in fluid communication with each of the discharge port. Where there is more than one discharge port, the feed conduit splits to supply each discharge port. In an embodiment, there is one discharge port having a direction of discharge and an associated axis, and at least two clamps symmetrically disposed about the axis. The apparatus may be clamped to a discharge conduit of the blower.

### RELATED APPLICATIONS

This application claims priority in accordance with 37 CF.R. 1.19(e) to U.S. Provisional Patent Application Ser. No. 62/363,134 filed for HAND HELD LEAF BLOWER EXTERNAL MOUNT LIQUID DISPENSING MIST NOZZLE ASSEMBLY filed Jul. 15, 2016 which is included herein in its entirety by reference.

### FIELD OF THE DISCLOSURE

The present disclosure relates to dispensers, and more particularly, to apparatus for converting a powered air blower to a dispenser dispensing a spray by adapting a spray dispenser to be mounted to the blower.

### BACKGROUND

Gasoline and electric powered air blowers have been provided for consumer use to perform certain tasks such as blowing leaves from sidewalks, driveways, and the like. Another consumer need, particularly for maintenance or operation of yards, gardens, and similar venues, is that of spraying chemicals. Herbicides, pesticides, and other chemicals are available for dispensed onto grass, shrubs, other plants, the ground, buildings, and other environmental objects. Some chemicals are commercially available with dedicated spray dispensers. Others are not so provided.

There exists a need to provide spray dispensers for chemicals not ordinarily provided with spray type dispensers.

### SUMMARY

The disclosed concepts address the above stated situation by providing a removal spray dispenser mountable to and usable in conjunction with a commercial powered air blower. Atomized or droplet discharge from the spray enters an air stream being discharged by the blower.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a perspective environmental view of apparatus for converting a powered air blower to a sprayer, according to at least one aspect of the disclosure;

FIG. 2 is a perspective environmental view of the apparatus of FIG. 1, rotated by about ninety degrees; and

FIG. 3 is a perspective environmental view of another embodiment of apparatus for converting a powered air blower to a sprayer, according to another aspect of the disclosure.

### DETAILED DESCRIPTION

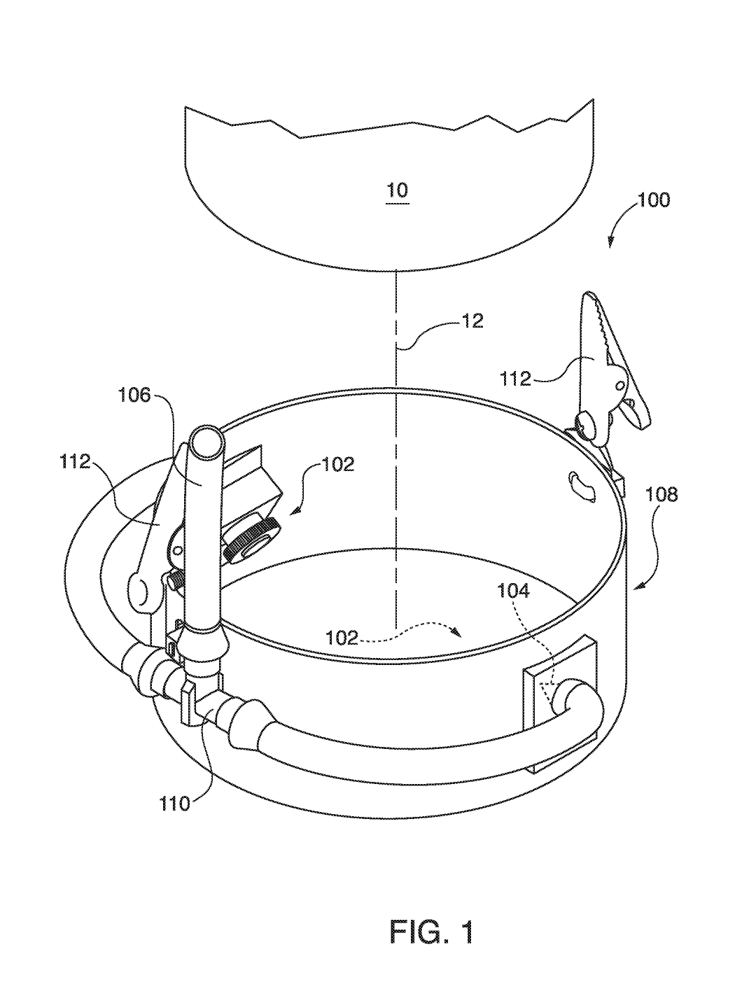

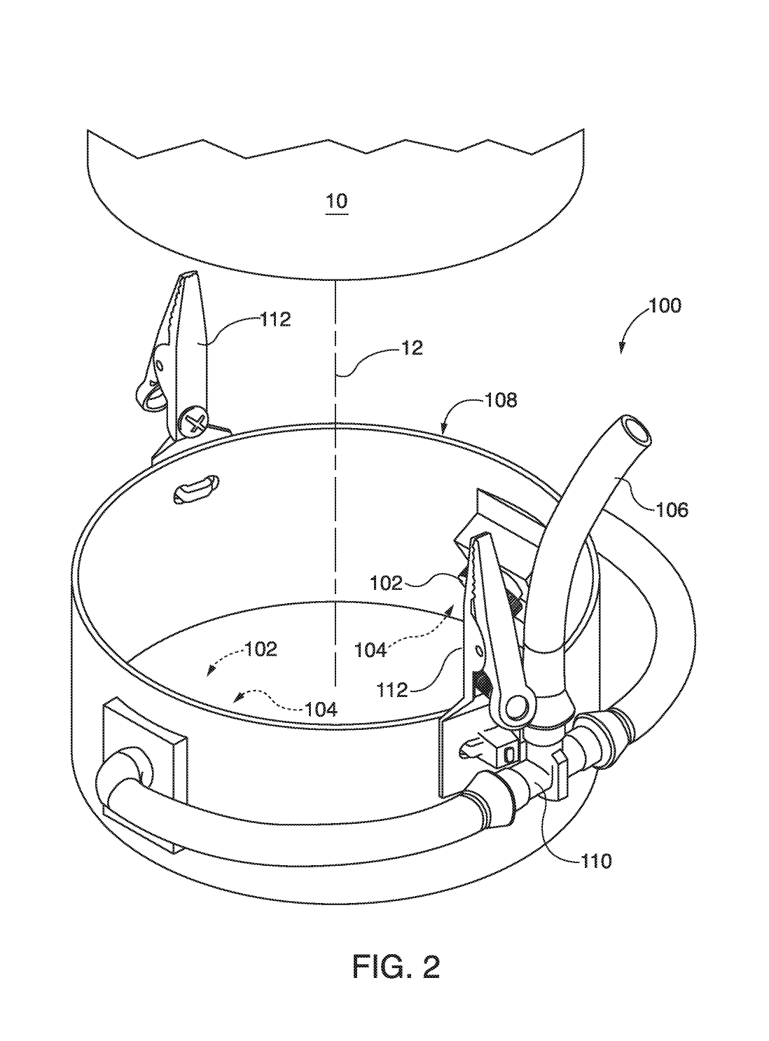

Referring first to FIGS. 1 and 2, according to at least one aspect of the disclosure, there is shown an apparatus 100 for converting a powered air blower (not shown in its entirety) having a discharge tube 10 to a sprayer. Apparatus 100 may comprise at least one discharge port 102 terminating in a spray nozzle 104, only one being visible in FIG. 1, a feed conduit 106 in fluid communication with each one of the at least one discharge port 102, and at least one clamp secured to the at least one discharge port 102 such that each one of the at least one discharge port 102 is held in a constant orientation to the at least one clamp. The at least one clamp couples apparatus 100 to discharge tube 10. Feed conduit 106 is to be connected to a supply of a fluid (not shown) to be dispensed, and conducts the fluid to each discharge port 102 and respective nozzle 104. The at least one clamp is sufficiently rigidly fixed in place such that when engaging discharge tube 10, thereby coupling apparatus 100 to discharge tube 10, each discharge port 102 is held such that a direction of discharge of fluid therefrom remains in substantially the same angle relative to a central axis 12 of discharge tube 10 in the course of routine use.

Apparatus 100 may further comprise a chassis 108, wherein each one of the at least one discharge port 102 and each one of the at least one clamp are mounted on chassis 108. Alternatively stated, chassis 108 provides a convenient structural platform for mounting functional components of apparatus 100. As depicted in FIGS. 1 and 2, chassis 108 may have a configuration of a tube similar in cross sectional dimensions and shape as discharge tube 10. Chassis 108 may be aligned to be coaxial with discharge tube 10.

Spray nozzle 104 has an aperture (not separately shown) so that fluid supplied under pressure will be discharged as droplets easily carried by air discharged from the powered air blower.

The at least one discharge port 102 may comprise a first discharge port 102 and a second discharge port 102 arranged to discharge a fluid (not shown) in mirror opposition to fluid discharged from first discharge port 102. That is, where two discharge ports 102 are provided, they are diametrically opposed to one another, and arranged to discharge fluids downwardly (as shown in FIGS. 1 and 2) at the same angle relative to chassis 108. This promotes intuitive or predictable and uniform dispersion of fluid droplets into the air discharged from the powered air blower.

It should be noted at this point that orientational terms such as downwardly refer to the subject drawing as viewed by an observer. The drawing figures depict their subject matter in orientations of normal use, which could obviously change with changes in body posture and position of a human user. Therefore, orientational terms must be understood to provide semantic basis for purposes of description only, and do not imply that their subject matter can be used only in one position.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Still referring to FIGS. 1 and 2, apparatus 100 may further comprise feed conduit 106 and a manifold 110 in fluid communication with supply conduit 106, first discharge port 102, and second discharge port 102. Thus, only one feed conduit 106 is required regardless of the number of discharge ports 102.

The apparatus of claim 1, wherein each one of the at least one clamp comprises an alligator jaw clamp 112. Alligator jaw clamps enable ready, intuitive connection to discharge tube 10.

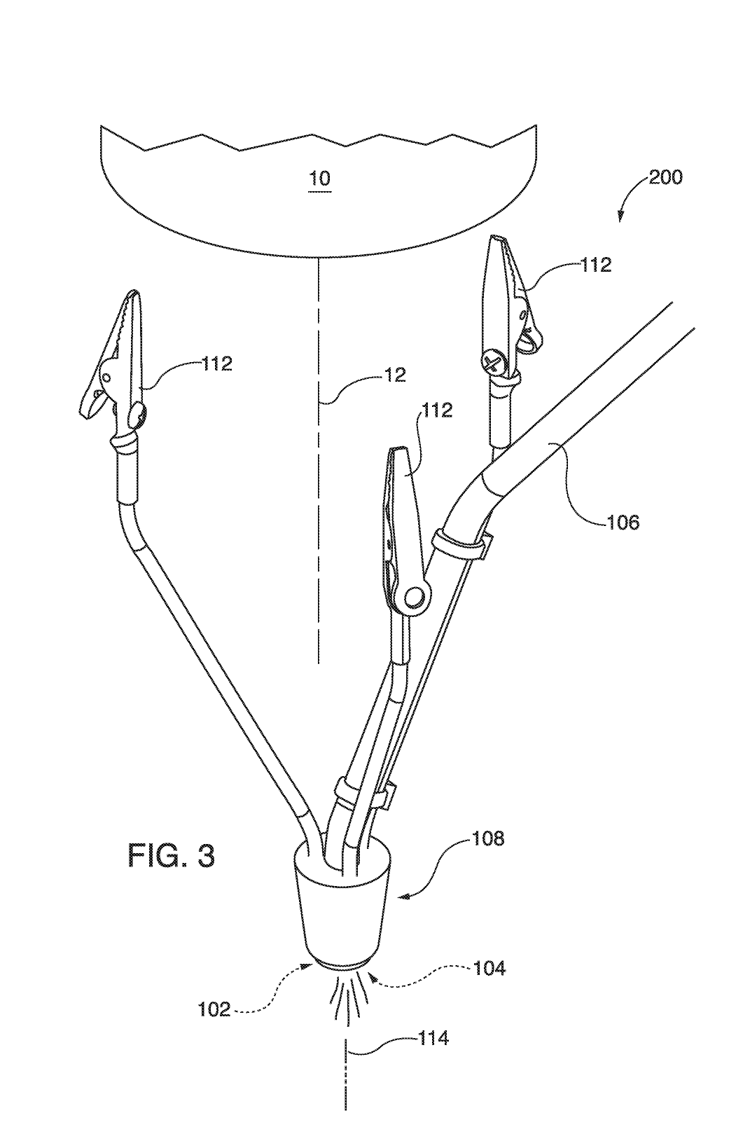

Turning now to FIG. 3, apparatus 200 is similar in purpose and function to apparatus 100, but is arranged such that it has a single discharge port 102 centered on central axis 12 of discharge tube 10 of the powered air blower. Apparatus 200 includes a discharge port 102 having a direction of discharge along an axis 114, and at least one clamp comprises at least a first alligator jaw clamp 112 and a second alligator jaw clamp 112. First alligator jaw clamp 112 and second alligator jaw clamp 112 both open in directions opposed to the direction of discharge. First alligator jaw clamp 112 and second alligator jaw clamp 112 are equidistantly spaced about axis 114. Axes 12 and 114 may be collinear so that spray intuitively aligns with discharge tube 10. Because of the single discharge port 102, apparatus 200 is more economical than apparatus 100.

The invention may be thought of as a method of converting a powered air blower to a sprayer. The method may comprise coupling at least one discharge port 102 connected to a feed conduit 106 to a discharge conduit 10 of the powered air blower such that a direction of discharge of associated spray nozzle 104 is generally aligned with a direction of air discharged from a discharge tube 10 of the powered air blower, coupling the at least one discharge port 102 to discharge tube 10 of the powered air blower, operating the powered air blower, and feeding fluid under pressure into discharge port 102 and subsequently into the air discharged from the powered air blower.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. Apparatus for converting a powered air blower having a discharge tube to a sprayer, the apparatus comprising:
at least one discharge port terminating in a spray nozzle;
a feed conduit in fluid communication with each one of the at least one discharge port; and
at least one clamp secured to the at least one discharge port such that each one of the at least one discharge port is held in a constant orientation to the at least one clamp.

2. The apparatus of claim 1, further comprising a chassis, wherein each one of the at least one discharge port and each one of the at least one clamp is mounted on the chassis.

3. The apparatus of claim 2, wherein the at least one discharge port comprises a first discharge port and a second discharge port arranged to discharge a fluid in mirror opposition to fluid discharged from the first discharge port.

4. The apparatus of claim 2, further comprising a supply conduit and a manifold in fluid communication with the supply conduit, the first discharge port, and the second discharge port.

5. The apparatus of claim 1, wherein each one of the at least one clamp comprises an alligator jaw clamp.

6. The apparatus of claim 2, wherein the chassis has a configuration of a tube.

7. The apparatus of claim 1, wherein
the discharge port has a direction of discharge along an axis;
the at least one clamp comprises at least a first alligator jaw clamp and a second alligator jaw clamp;
the first alligator jaw clamp and the second alligator jaw clamp both open in directions opposed to the direction of discharge;
the first alligator jaw clamp and the second alligator jaw clamp are equidistantly spaced about the axis.

8. A method of converting a powered air blower to a sprayer, the method comprising:
coupling at least one discharge port connected to a feed conduit to a discharge conduit of the powered air blower such that a direction of discharge of an associated nozzle is generally aligned with a direction of air discharged from a discharge tube of the powered air blower;
coupling the at least one discharge port to the discharge tube of the powered air blower;
operating the powered air blower; and
feeding fluid under pressure into the discharge port and subsequently into the air discharged from the powered air blower.
